(19) United States
(12) Patent Application Publication
(10) Pub. No.: US 2026/0168903 A1
(43) Pub. Date: Jun. 18, 2026

(54) NOISE AND VIBRATION MEASUREMENT APPARATUS FOR COUPLING PARTS

(71) Applicants: HYUNDAI MOTOR COMPANY, Seoul (KR); KIA CORPORATION, Seoul (KR); KOREA UNIVERSITY RESEARCH & BUSINESS FOUNDATION, Seoul (KR)

(72) Inventors: Kyung Woo Lee, Hwaseong-si (KR); Dae Un Sung, Hwaseong-si (KR); Seong Ho Yoon, Seoul (KR); Jun Young Yoon, Seoul (KR); Byoung Ho Choi, Seoul (KR); Sang Min Lee, Seoul (KR)

(73) Assignees: HYUNDAI MOTOR COMPANY, Seoul (KR); KIA CORPORATION, Seoul (KR); KOREA UNIVERSITY RESEARCH & BUSINESS FOUNDATION, Seoul (KR)

(21) Appl. No.: 19/327,845

(22) Filed: Sep. 12, 2025

(30) Foreign Application Priority Data
Dec. 17, 2024 (KR) 10-2024-0188789

(51) Int. Cl. G01N 3/30

(52) U.S. Cl. CPC G01N 3/30

(57) ABSTRACT

An apparatus includes a velocity application unit configured to generate horizontal friction between a pair of test specimens, a load application unit configured to generate vertical friction between the pair of test specimens, and an impact application unit connected to the load application unit. The impact application unit is configured to regulate the distance between the pair of test specimens and to provide impact at a specific velocity. The apparatus also includes a measurement unit configured to measure the intensity of one or both of noise or vibration generated by friction and impact provided to the pair of test specimens. The apparatus additionally includes a controller configured to process noise and vibration data measured by the measurement unit.

### CROSS-REFERENCE TO RELATED APPLICATION

This application claims the benefit of and priority to Korean Patent Application No. 10-2024-0188789, filed on Dec. 17, 2024, the entire contents of which are hereby incorporated herein by reference.

### BACKGROUND

### Technical Field

The present disclosure relates to an apparatus capable of measuring noise and vibration generated between parts coupled to each other.

### Discussion of the Related Art

In general, noise generated in a vehicle includes combustion noise from an engine, noise generated between tires and a road surface, and noise generated between various coupling parts mounted in the vehicle.

The coupling parts are mainly used for trim coupling, and therefore noise generated between the coupling parts is not as loud as the combustion noise or the noise generated between the tires and the road surface. However, most of the noise is generated in a cabin where passengers are, and engine noise and tire noise are gradually decreasing. For example, engine noise is not generated in electric vehicles. As a result, the noise generated between the coupling parts gradually becomes relatively louder, which is a factor that reduces affective quality.

The noise generated between the coupling parts is divided into buzz caused by resonance, squeak caused by friction between adjacent parts, and rattle caused by the impact of adjacent parts.

As the number of quiet vehicles has increased in recent years, noise that was previously concealed by the existing driving noise has become more noticeable, making it more important to have a system that can evaluate the noise. However, conventional test equipment was designed to measure either squeak noise caused by friction or rattle noise caused by impact, and could not measure both of the noises with a single apparatus.

In addition, due to the nature of polymer materials, the range of physical properties is very large and diverse, and the behavior and vibration noise characteristics vary greatly depending on the stiffness of the system in which materials are used. Furthermore, conventional friction testing equipment cannot adjust stiffness and only have single system stiffness, whereby it is not possible to simulate the stiffness of the system or environment in which actual materials are used.

The statements in this section merely provide background information related to the present disclosure and may not constitute prior art.

### SUMMARY OF THE DISCLOSURE

Embodiments of the present disclosure provide a noise and vibration measurement apparatus for coupling parts that substantially obviates one or more problems due to limitations and disadvantages of the related art.

Embodiments of the present disclosure provide a noise and vibration measurement apparatus for coupling parts capable of measuring noise, vibration, and force generated when friction and impact are applied to a pair of polymer specimens for vehicles using a single apparatus.

Embodiments of the present disclosure provide a noise and vibration measurement apparatus for coupling parts capable of simulating an actual operating environment by changing the system stiffness of the measurement apparatus.

According to an embodiment, a noise and/or vibration measurement apparatus for coupling parts is provided. The apparatus includes a velocity application unit configured to generate horizontal friction between a pair of test specimens. The apparatus also includes a load application unit configured to generate vertical friction between the pair of test specimens. The apparatus additionally includes an impact application unit connected to the load application unit. The impact application unit is configured to regulate a distance between the pair of test specimens and to provide impact at a predetermined velocity. The apparatus further includes a measurement unit configured to measure an intensity of one or both of noise or vibration generated by the pair of test specimens. The also includes a controller configured to control the velocity application unit, the load application unit, and the impact application unit, and to process noise or vibration data measured by the measurement unit. The apparatus further includes a display unit configured to display a graph associated with the processed data.

In an embodiment, the apparatus may further include a frame including an aluminum breadboard and a steel frame, wherein the steel frame may be coupled and fixed to the aluminum breadboard together with the velocity application unit.

In an embodiment, the velocity application unit may include a first servomotor configured to provide rotational power according to a control signal from the controller, and an actuator configured to convert rotational motion of the first servomotor into horizontal linear motion.

In an embodiment, the velocity application unit may further include a coupling member connected to a rotating shaft of the servomotor to transmit rotational force of the servomotor to the actuator, and a lower end plate configured to fix a lower one of the pair of test specimens thereon, and to move according to an operation of the actuator such that friction force is provided through the lower specimen.

In an embodiment, the load application unit may include a load plate configured to provide vertical load to the pair of test specimens, and a pair of linear motion guides (LM guides) coupled to the steel frame and configured to vertically guide the load plate.

In an embodiment, the load application unit may further include a stiffness adjustment plate coupled to a central region of the load plate and configured to adjust stiffness applied to the pair of test specimens depending on a distance therefrom, and a specimen holder disposed under the stiffness adjustment plate and configured to fix an upper one of the pair of test specimens.

In an embodiment, the impact application unit may include a second servomotor configured to provide rotational force according to a control signal from the controller, a rack and pinion gear unit configured to convert rotational motion of the second servomotor into vertical motion, and a fixing unit configured to fix the second servomotor to the frame and to couple one end of the load plate to a rack gear of the rack and pinion gear unit.

In an embodiment, the second servomotor may provide velocity and torque set during an impact test without affecting vertical load during a friction test by the load application unit.

In an embodiment, the noise and vibration measurement apparatus may further include a servomotor holder configured to fix the second servomotor to one side of the steel frame while supporting the second servomotor.

In an embodiment, the measurement unit may include a first load cell disposed between the linear motion guide and the stiffness adjustment plate, the first load cell configured to measure frictional force, a second load cell disposed between the stiffness adjustment plate and the specimen holder, the second load cell configured to measure vertical load, an accelerometer attached to the specimen holder, the accelerometer configured to measure vibration generated during a test, and a microphone configured to measure noise generated during the test.

In an embodiment, the test specimens may be made of a same material, such as a polymer and a polymer or a metal and a metal.

In an embodiment, the test specimens made may be made of different materials, such as rubber and plastic or rubber and a metal.

It should be understood that both the foregoing general description and the following detailed description of the present disclosure are illustrative and explanatory and are intended to provide a detailed description of the present disclosure as claimed.

### BRIEF DESCRIPTION OF THE DRAWINGS

The accompanying drawings, which are included to provide a further understanding of the present disclosure and are incorporated in and constitute a part of this application, illustrate embodiment(s) of the present disclosure and together with the description serve to explain the principle of the present disclosure. In the drawings:

FIG. 1 is a block diagram schematically showing the overall configuration of a noise and vibration measurement apparatus for coupling parts, according to an embodiment of the present disclosure;

FIGS. 2A-C are illustrative views showing the overall configuration of the noise and vibration measurement apparatus for coupling parts, according to an embodiment of the present disclosure;

FIGS. 3A-E are illustrative views showing the configuration of a velocity application unit of the noise and vibration measurement apparatus for coupling parts, according to an embodiment of the present disclosure;

FIGS. 4A-E are illustrative views showing the configuration of a load application unit of the noise and vibration measurement apparatus for coupling parts, according to an embodiment of the present disclosure;

FIGS. 5A-C are illustrative views showing the configuration of an impact application unit of the noise and vibration measurement apparatus for coupling parts, according to an embodiment of the present disclosure;

FIGS. 6A and 6B are illustrative graphs showing the measurement results using the noise and vibration measurement apparatus for coupling parts, according to an embodiment of the present disclosure; and

FIGS. 7A and 7B are graphs showing the vibration acceleration level in the frequency domain when the friction velocity is fixed and the system stiffness is changed, according to an embodiment of the present disclosure.

### DETAILED DESCRIPTION OF THE DISCLOSURE

Specific structural or functional descriptions of the embodiments of the present disclosure disclosed in this specification are provided only as illustrating embodiments of the present disclosure. Embodiments of the present disclosure may be realized in various forms, and should not be interpreted to be limited to the embodiments of the present disclosure disclosed in this specification.

Since the present disclosure may be variously modified and may have various forms, specific embodiments are shown in the drawings and are described in detail in this specification. However, the present disclosure is not limited to the specific embodiments, and it should be understood that the present disclosure includes all alterations, equivalents, and substitutes that fall within the idea and technical scope of the present disclosure.

It should be understood that, although the terms “first”, “second”, etc. may be used herein to describe various elements, corresponding elements should not be understood to be limited by these terms. Rather, these terms are used only to distinguish one element from another. For example, within the scope of the present disclosure, a first element may be referred to as a second element, and similarly, a second element may be referred to as a first element.

It should be understood that, when an element is referred to as being “connected to” or “coupled to” another element, the element may be directly connected to or coupled to the other element, or one or more intervening elements may be present. In contrast, when an element is referred to as being “directly connected to” or “directly coupled to” another element, there are no intervening elements present. Other terms that describe the relationship between elements, such as “between” and “directly between” or “adjacent to” and “directly adjacent to”, should be interpreted in the same manner. Similarly, “disposed on” may mean that an element is disposed directly on the surface of another element or disposed above another element so as to be spaced apart therefrom.

The terms used in this specification are provided only to explain specific embodiments, but are not intended to limit the present disclosure. A singular representation may include a plural representation unless it represents a definitely different meaning from the context. It should be further understood that the terms “includes”, “comprises”, “has” and the like, when used in this specification, specify the presence of stated features, numbers, steps, operations, elements, components, or combinations thereof, but do not preclude the presence or addition of one or more other features, numbers, steps, operations, elements, components, or combinations thereof.

Unless otherwise defined, all terms, including technical and scientific terms, used in this specification have the same meanings as those commonly understood by a person having ordinary skill in the art to which the present disclosure pertains. It should be further understood that terms, such as those defined in commonly used dictionaries, should be interpreted as having meanings consistent with their meanings in the context of the relevant art and the present disclosure, and should not be interpreted in an idealized or overly formal sense unless expressly so defined herein.

When a certain embodiment is differently realized, a function or operation specified in a specific block may be performed differently from the sequence specified in a flowchart. For example, two continuous blocks may be substantially simultaneously performed, or the blocks may be performed in reverse order depending on related functions or operations.

When a component, controller, device, element, unit, application, application portion, apparatus, or the like of the present disclosure is described as having a purpose or performing an operation, function, or the like, the component, controller, device, element, unit, application, application portion, apparatus, or the like should be considered herein as being “configured to” meet that purpose or to perform that operation or function. Where appropriate, each component, controller, device, element, unit (e.g., display unit), application, application portion, apparatus, and the like may separately embody or be included with a processor and a memory, such as a non-transitory computer readable media, as part of the apparatus.

Hereinafter, a noise and/or vibration measurement apparatus for coupling parts according to embodiments of the present disclosure is described in detail with reference to the accompanying drawings.

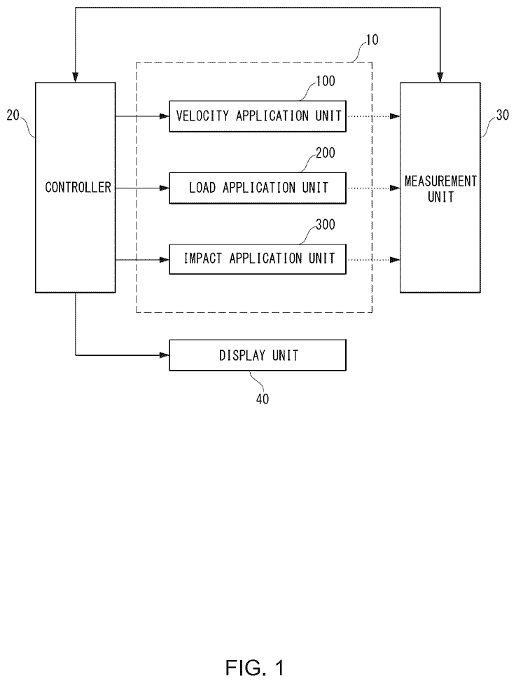

FIG. 1 is a block diagram schematically showing the overall configuration of a noise and vibration measurement apparatus for coupling parts, according to an embodiment of the present disclosure. As shown, the noise and vibration measurement apparatus for coupling parts according to an embodiment of the present disclosure includes a test device 10, a measurement unit 30 configured to measure noise, vibration, and frictional force through the test device 10, a controller 20 configured to control the test device 10 and to process noise and vibration data measured by the measurement unit 30, and a display unit 40 configured to display the results processed by the controller 20 in the form of a graph.

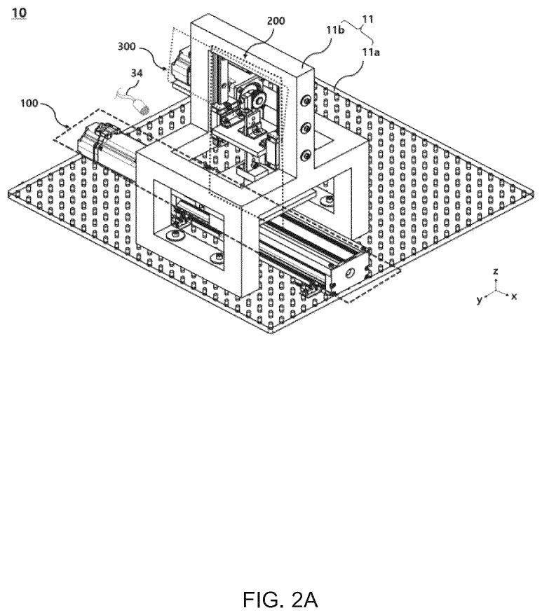

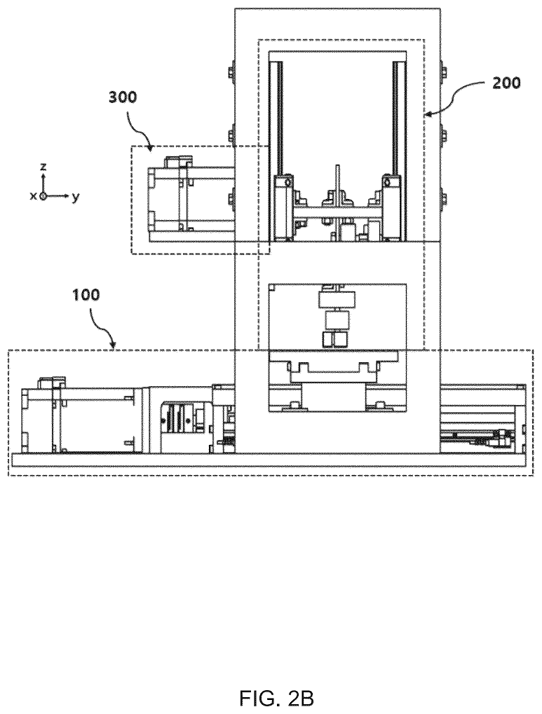

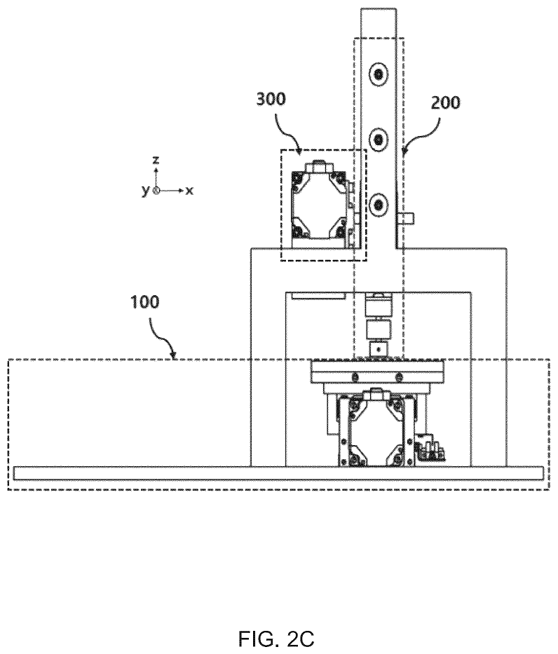

FIGS. 2A-C are illustrative views showing the overall configuration of the noise and vibration measurement apparatus for coupling parts, according to an embodiment of the present disclosure. FIG. 2A is a perspective view showing the test device 10, FIG. 2B is a side view of the test device 10 when viewed in an x-axis direction, and FIG. 2C is a front view of the test device 10 when viewed in a y-axis direction.

The test device 10 comprises a velocity application unit 100, a load application unit 200, and an impact application unit 300 disposed on a frame 11.

The velocity application unit 100, indicated by a dotted line in the figures, generates horizontal friction between a pair of test specimens, the load application unit 200, indicated by a dotted line in the figures, generates vertical friction between the pair of test specimens, and the impact application unit 300, indicated by a dotted line in the figures, is connected to the load application unit 200 to regulate the distance between the pair of test specimens and to provide impact at a specific velocity.

When describing the disposition relationship based on the pair of specimens, a lower one of the pair of specimens is disposed at the velocity application unit 100, and an upper specimen is disposed at the load application unit 200. In an embodiment, the velocity application unit 100 is disposed lower than the lower specimen to provide the frictional force according to the change in velocity through the lower specimen, and the load application unit 200 is disposed so as to be fixed to an upper end of a steel frame 11b above the upper specimen by bolt coupling to provide the frictional environment according to the change in weight and stiffness through the upper specimen. In an embodiment, the impact application unit 300 may be coupled to one side of the load application unit 200 to provide impact to the upper specimen through the load application unit 200.

The pair of specimens may be made of the same material, such as a polymer and a polymer or a metal and a metal, or different materials, such as rubber and plastic or rubber and a metal.

In order to measure noise, vibration, and/or friction force that may occur during operation when coupling parts are mounted in a vehicle, noise, vibration, and friction force may be measured using the coupling parts mounted in the vehicle while being coupled to each other as the pair of specimens.

As shown in FIG. 2A, a frame 11 includes an aluminum breadboard 11a and a steel frame 11b. The steel frame 11b is fixed to the aluminum breadboard 11a together with the velocity application unit 100 by bolting coupling. Noise generated during a test process is measured by a microphone 34 disposed adjacent to the specimens.

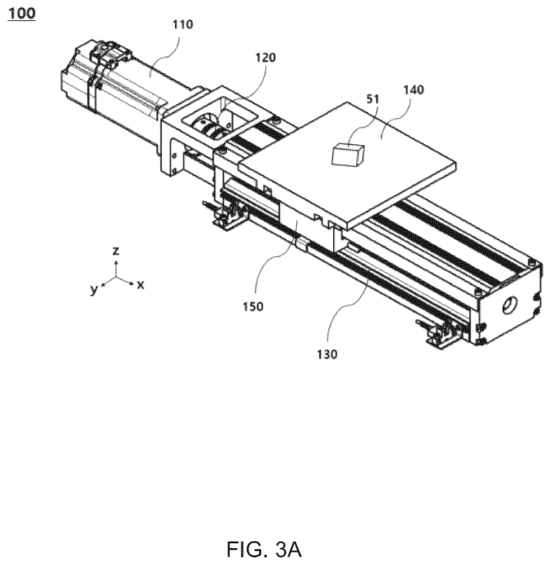

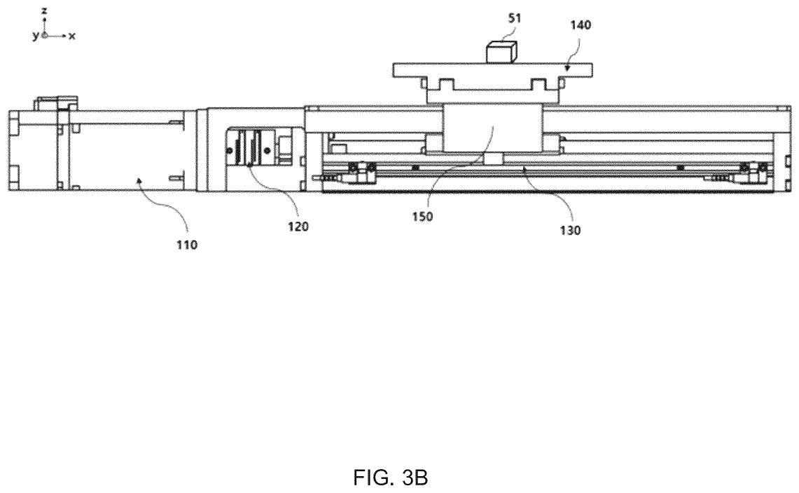

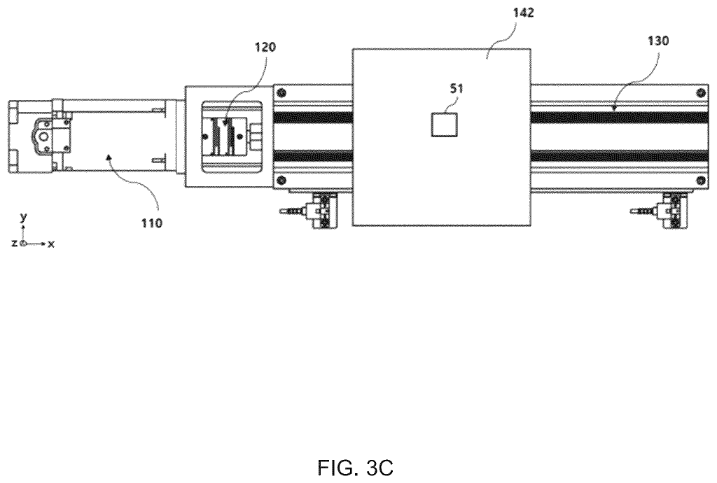

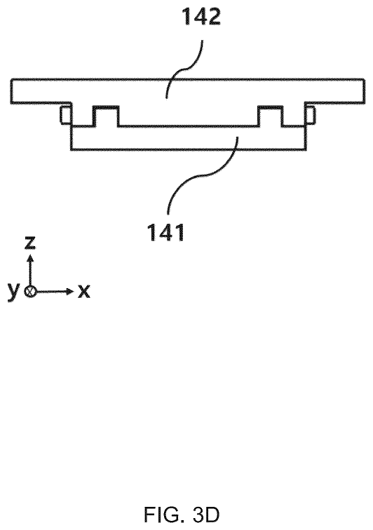

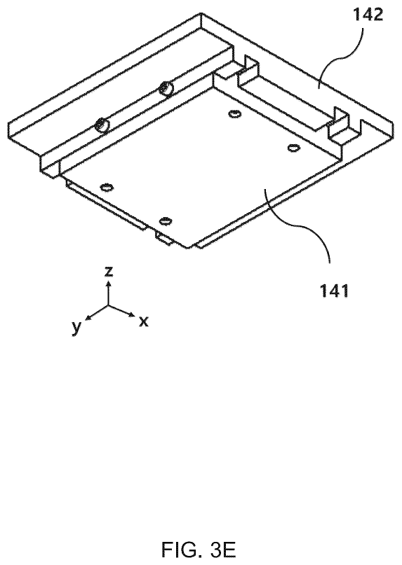

FIGS. 3A-E are illustrative views showing the configuration of the velocity application unit of the noise and vibration measurement apparatus for coupling parts, according to an embodiment of the present disclosure. FIG. 3A is a perspective view showing the velocity application unit 100, FIG. 3B is a front view of the velocity application unit 100 when viewed in the y-axis direction, and FIG. 3C is a plan view of the velocity application unit 100 when viewed in a z-axis direction.

The velocity application unit 100 includes a first servomotor 110, an actuator 130, a coupling 20, and a lower end plate 240.

The first servomotor 110 provides rotational power according to a control signal from the controller 20. The actuator 130 converts the rotational motion of the first servomotor 110 into linear motion and is operated in a horizontal direction. The coupling 120 is connected to a rotating shaft of the servomotor 110 to transmit the rotational force of the servomotor 110 to the actuator 130. The lower end plate 140 is coupled to the actuator 130 via a connection portion 150.

The lower end plate 140 comprises a lower part 141 of the lower end plate and an upper part 142 of the lower end plate coupled to each other, as shown in FIGS. 3D and E. FIG. 3D is a front view of the lower end plate 140 when viewed in the y-axis direction, and FIG. 3E is a rear perspective view of the lower end plate 140 when viewed from below.

The lower one of the pair of test specimens is fixed to a surface of the upper part 142 of the lower end plate 140. The lower part 141 of the lower end plate is connected to the actuator 130 via the connection portion 150. The straight movement of the actuator 130 is transmitted to the lower specimen fixed to the surface of the upper part of the lower end plate 140 such that the lower specimen moves in a straight line.

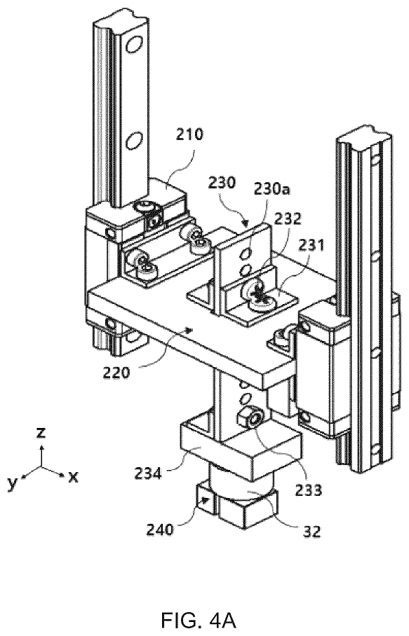

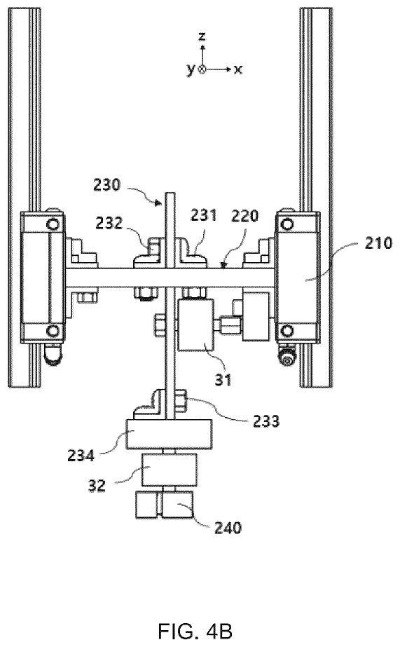

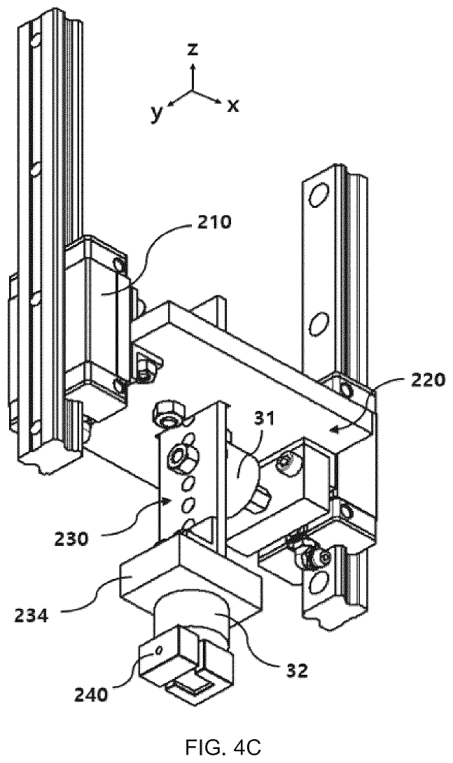

FIGS. 4A-E are illustrative views showing the configuration of the load application unit of the noise and vibration measurement apparatus for coupling parts according to the present disclosure. FIG. 4A is a perspective view of the load application unit 200, 4B is a front view of the load application unit 200 when viewed in the y-axis direction, and FIG. 4C is a rear perspective view of the load application unit 200 when viewed in the x-axis direction.

As shown, the load application unit 200 includes a load plate 220, linear motion guides (LM guides) disposed on both sides of the load plate 220, a stiffness adjustment plate 230 inserted into a hole 221 formed in the center of the load plate 220, and a specimen holder 240 disposed under of the stiffness adjustment plate 230.

The load plate 220 has a square panel shape, and provides vertical load to the test specimen under test through the stiffness adjustment plate 230 inserted into the hole 221 formed in the center thereof.

The pair of linear motion guides (LM guides) 210 coupled to both sides of the load plate 220 is connected to respective vertical frames of the steel frame 11b. The linear motion guides 210 guide the load plate 220 so as to move vertically along the vertical frames of the steel frame 11b without moving left or right.

A part of the stiffness adjustment plate 230 is inserted into the insertion hole 221 formed in the center of the load plate 220, and the stiffness adjustment plate 230 is coupled to the load plate 220 via a plate coupling portion 231 by bolt fastening. A plurality of holes 230a is formed in the stiffness adjustment plate 230, and the distance from the specimen is adjusted by a height adjustment pin 232 inserted into one of the holes. The stiffness applied to the specimen may be increased by reducing the distance from the specimen. On the other hand, the stiffness applied to the specimen may be reduced by increasing the distance from the specimen. That is, the stiffness applied to the specimen may be adjusted by adjusting the distance from the specimen. A weight 234 is connected to one of the plurality of holes 230a via a weight coupling portion 233.

A first load cell 31 is disposed between the linear motion guide 310 and the stiffness adjustment plate 230. The first load cell 31 measures the frictional force applied to the upper specimen 52 fixed to the specimen holder 240 by the stiffness adjustment plate 230.

A second load cell 32 is disposed between the weight 234 connected to a lower end of the stiffness adjustment plate 230 and the specimen holder 240. The second load cell 32 measures the load applied to the upper specimen 52 fixed to the specimen holder 240 via the weight 234.

FIG. 4D is a perspective view of the specimen holder 240, and FIG. 4E is a rear perspective view of the specimen holder 240 when viewed in the y-axis direction. The specimen holder 240 is disposed under the stiffness adjustment plate 230 to fix the upper one 52 of the pair of test specimens.

A receiving space 242-a, into which the upper specimen 52 is inserted, is formed in a second specimen holder 242. A first specimen holder 241, which is disposed so as to face the second specimen holder 242, is coupled to the second specimen holder 242 to fix the upper specimen 52. An accelerometer 33 is attached to a rear surface 242-b of the second specimen holder 242 to measure vibration generated during the test.

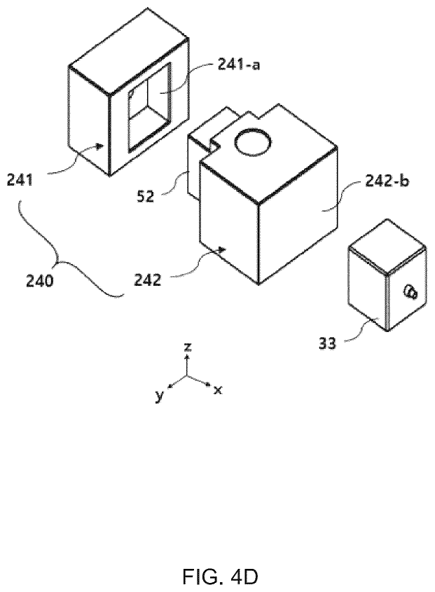

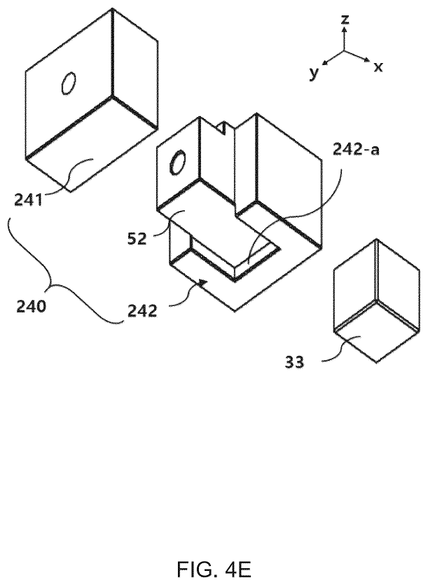

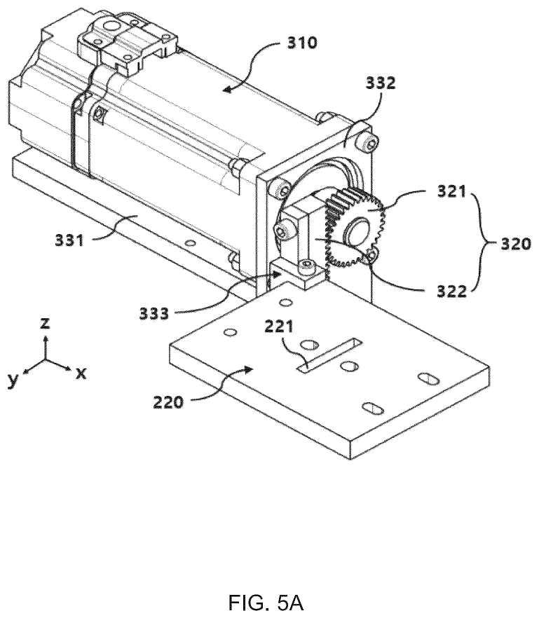

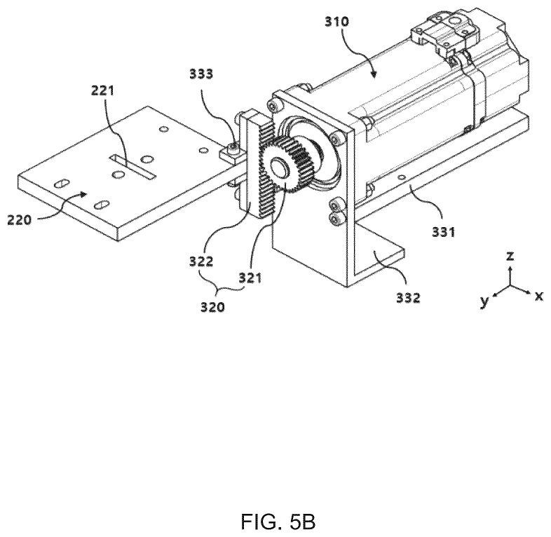

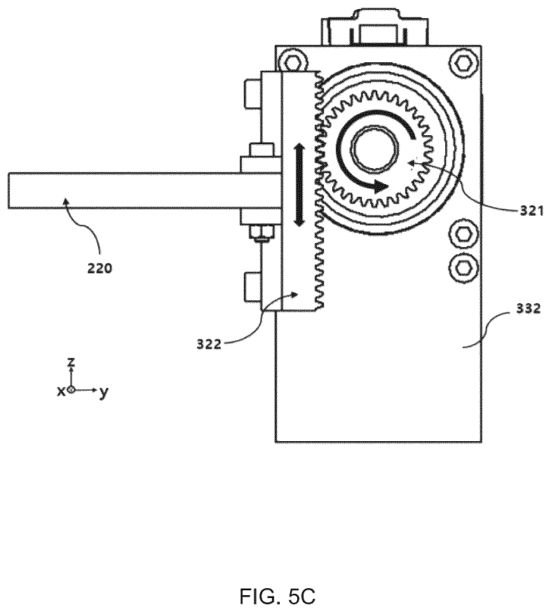

FIGS. 5A-C are illustrative views showing the configuration of the impact application unit of the noise and vibration measurement apparatus for coupling parts, according to an embodiment of the present disclosure. FIG. 5A is a perspective view of the impact application unit 300 when viewed in the y-axis direction, FIG. 5B is a perspective view of the impact application unit 300 when viewed in an axial direction, and FIG. 5C is a side view of the impact application unit 300 when viewed in the x-axis direction.

The impact application unit 300 includes a second servomotor 310, a rack and pinion gear unit 320, and a fixing unit 330, and serves to regulate the distance between the pair of specimens and to apply impact to the pair of specimens at a specific velocity.

The second servomotor 310 provides rotational force according to a control signal from the controller. The rack and pinion gear unit 320 includes a circular pinion gear 321 and a bar-shaped rack gear 322, and converts the rotational motion of the second servomotor 310 into vertical motion. The center of the circular pinion gear 321 is connected to a rotating shaft of the second servomotor 310, and the circular pinion gear transmits power to the rack gear 322 upon rotation. As shown in FIG. 5C, the rack gear 322 engaged with the pinion gear 321 converts the rotational motion of the pinion gear 321 into linear actuation. The fixing unit 330 includes a motor holder lower plate 331 disposed under the second servomotor 310 to support the second servomotor 310, a motor holder coupling portion 332 disposed at a side surface of the second servomotor 310 to couple the second servomotor 310 to the steel frame 11b, and a rack coupling portion 33 configured to couple one end of the load plate 220 to the rack gear of the rack and pinion gear unit 320. The rotational velocity of the second servomotor 310 is proportional to the amount of impact applied to the pair of specimens through the vertical movement of the load application unit 300. Accordingly, the force generated by the rotation of the second servomotor 310 is transmitted to the pinion gear 321 connected to the rotating shaft of the second servomotor 310. The rotational force of the pinion gear 321 is transmitted as the linear motion of the rack gear 322 and converted into vertical acceleration of the load plate 220 coupled by the rack coupling portion 333.

The torque of the second servomotor 310 is set to “0” when vertical load is applied using the weight 234 during a friction test by the load application unit 200, whereby the set velocity and torque are provided during an impact test without affecting the vertical load. The second servomotor 310 may set the vertical load through feedback control if the vertical load is not applied using the weight during the friction test.

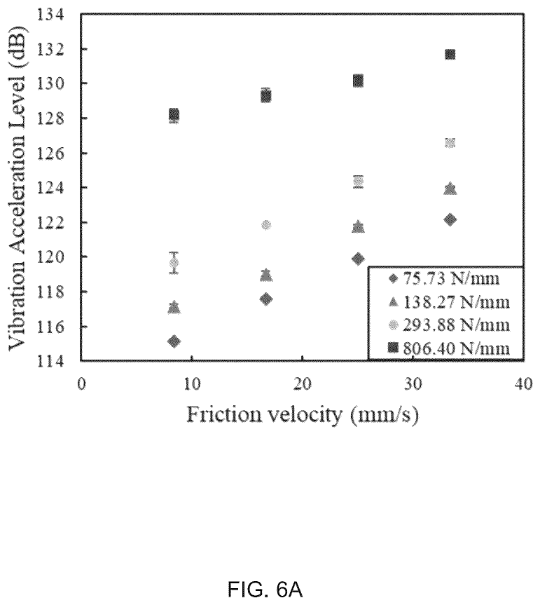

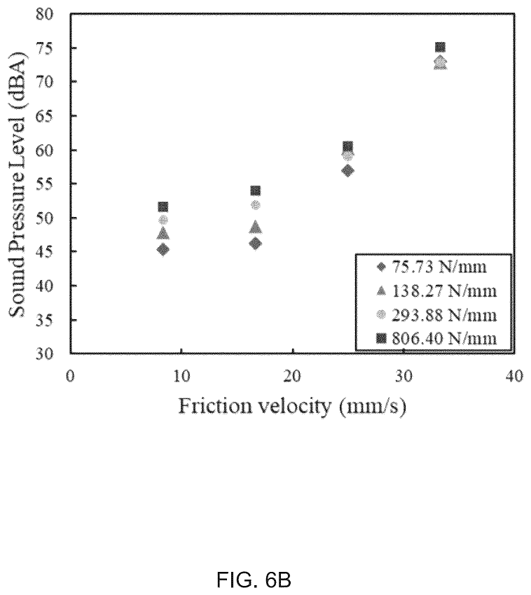

FIGS. 6A and 6B are illustrative graphs showing measurement results obtained using the noise and vibration measurement apparatus for coupling parts, according to an embodiment of the present disclosure.

The graphs show the vibration acceleration level for the friction velocity while increasing the friction velocity for a single material (x-axis). There are shown the measurement results of vibration acceleration level and sound pressure level that occur under the conditions that the specimen is moved at a friction velocity of 8.33 millimeters per second (mm/s), 16.67 mm/s, 25.00 mm/s, and 33.00 mm/s through the velocity application unit 100, as shown in FIGS. 3A-E, and the stiffness conditions (75.73 Newtons per millimeter (N/mm), 138.27 N/mm, 293.88 N/mm, and 806.40 N/mm) applied to the specimen are changed using the stiffness adjustment plate 230 of the load application unit 200, as shown in FIGS. 4A-C.

[Table 1] shows acceleration level values for changes in friction velocity and stiffness conditions. FIG. 6A shows the measured values shown in [Table 1] below as a graph.

TABLE 1

| | |
|---|---|
| Vibration | |
| Acceleration | System Stiffness (N/mm) |

| Level(dB) | | 75.73 | 138.27 | 293.88 | 806.40 |
|---|---|---|---|---|---|
| Velocity | 8.33 | 115.13 | 117.17 | 119.66 | 128.16 |
| (mm/s) | 16.67 | 117.60 | 119.01 | 121.84 | 129.33 |
| | 25.00 | 119.92 | 121.79 | 124.34 | 130.18 |
| | 33.33 | 122.19 | 124.04 | 126.59 | 131.69 |

[Table 2] shows sound pressure levels values for changes in friction velocity and stiffness conditions. FIG. 6B shows the measured values shown in [Table 2] below as a graph.

TABLE 2

| | |
|---|---|
| Sound Pressure | System Stiffness (N/mm) |

| | | | | |
|---|---|---|---|---|
| Level(dBA) | 75.73 | 138.27 | 293.88 | 806.40 |

| | | | | | |
|---|---|---|---|---|---|
| Velocity | 8.33 | 45.41 | 46.18 | 56.89 | 73.06 |
| (mm/s) | 16.67 | 47.86 | 48.75 | 60.20 | 72.87 |
| | 25.00 | 49.72 | 51.90 | 59.04 | 72.82 |
| | 33.33 | 51.65 | 53.92 | 60.51 | 75.06 |

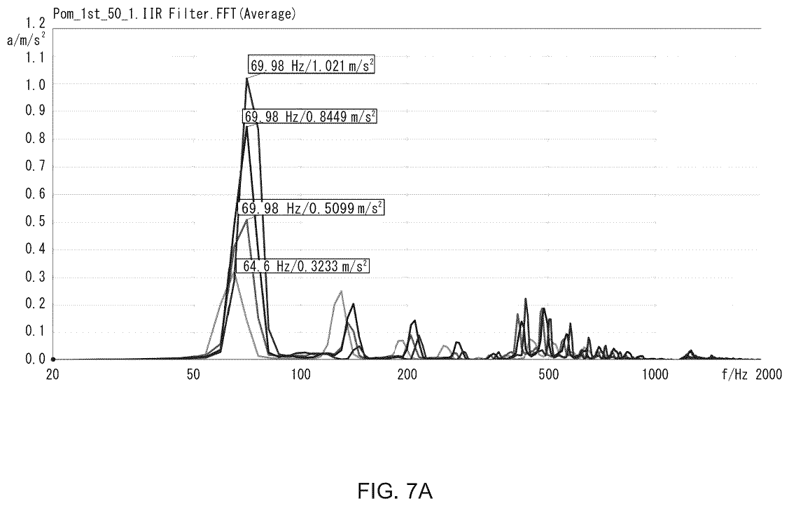

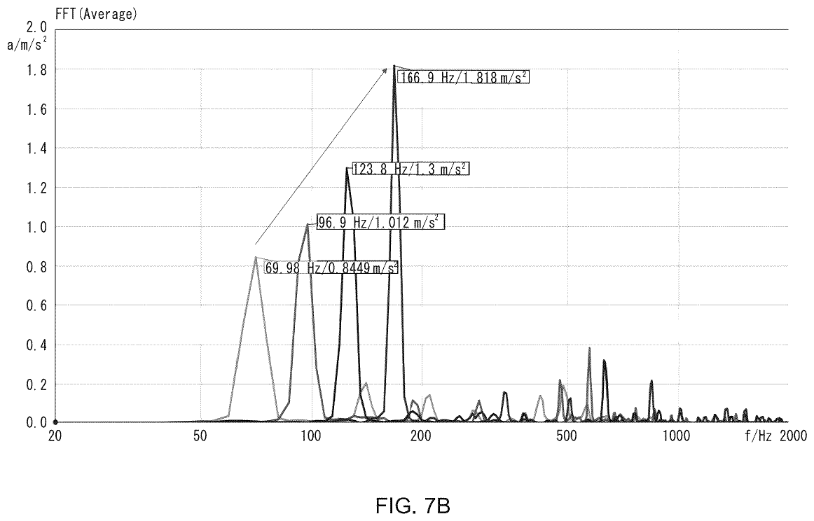

FIG. 7A shows that, when the system stiffness is fixed to 75.73 N/mm the friction velocity is changed, the vibration acceleration level is expressed as a frequency domain value using a Fast Fourier Transform algorithm. FIG. 7B shows that, when the friction velocity is fixed to 25.00 mm/s and the system stiffness is changed, the vibration acceleration level is expressed as a frequency domain value using the Fast Fourier Transform algorithm.

As described above, in the noise and vibration measurement apparatus for coupling parts according to embodiments of the present disclosure, it is possible to measure all of squeak and rattle noise, vertical drag force, and vibration caused by friction and impact using one apparatus by providing velocity and load conditions, whereby it is possible to identify the relationship between data and evaluate the characteristics.

As is apparent from the above description, in the noise and vibration measurement apparatus for coupling parts according to embodiments of the present disclosure, it is possible to set desired velocity and conditions through a single apparatus, to measure all of squeak and rattle noise, vibration, and force caused by friction and impact, and to change the system stiffness of the measurement apparatus, thereby achieving the effect of simulating the actual operating environment.

Although example embodiments of the present disclosure are described above with reference to the accompanying drawings, those having ordinary skill in the art should appreciate that various modifications and alterations are possible without departing from the idea and field of the present disclosure set forth in the appended claims.

What is claimed is:

1. An apparatus comprising:
a velocity application unit configured to generate horizontal friction between a pair of test specimens;
a load application unit configured to generate vertical friction between the pair of test specimens;
an impact application unit connected to the load application unit, the impact application unit configured to regulate a distance between the pair of test specimens and to provide impact at a predetermined velocity;
a measurement unit configured to measure an intensity of one or both of noise or vibration generated by the pair of test specimens;
a controller configured to control the velocity application unit, the load application unit, and the impact application unit, and to process noise or vibration data measured by the measurement unit; and
a display unit configured to display a graph associated with the processed data.

2. The apparatus according to claim 1, further comprising a frame comprising an aluminum breadboard and a steel frame, wherein the steel frame is coupled and fixed to the aluminum breadboard together with the velocity application unit.

3. The apparatus according to claim 2, wherein the velocity application unit includes:
a first servomotor configured to provide rotational power according to a control signal from the controller; and
an actuator configured to convert rotational motion of the first servomotor into horizontal linear motion.

4. The apparatus according to claim 3, wherein the velocity application unit further includes:
a coupling member connected to a rotating shaft of the first servomotor to transmit rotational force of the first servomotor to the actuator; and
a lower end plate configured to:
fix a lower specimen of the pair of test specimens thereon, and
move according to an operation of the actuator such that friction force is provided through the lower specimen.

5. The apparatus according to claim 3, wherein the load application unit includes:
a load plate configured to provide vertical load to the pair of test specimens; and
a pair of linear motion guides (LM guides) coupled to the steel frame and configured to vertically guide the load plate.

6. The apparatus according to claim 5, wherein the load application unit further includes:
a stiffness adjustment plate coupled to a central region of the load plate and configured to adjust stiffness applied to the pair of test specimens depending on a distance therefrom; and
a specimen holder disposed under the stiffness adjustment plate and configured to fix an upper one of the pair of test specimens.

7. The apparatus according to claim 6, wherein the impact application unit includes:
a second servomotor configured to provide rotational force according to a control signal from the controller;
a rack and pinion gear unit configured to convert rotational motion of the second servomotor into vertical motion; and
a fixing unit configured to fix the second servomotor to the frame and to couple one end of the load plate to a rack gear of the rack and pinion gear unit.

8. The apparatus according to claim 7, wherein the second servomotor provides velocity and torque set during an impact test without affecting vertical load during a friction test by the load application unit.

9. The apparatus according to claim 7, further comprising a servomotor holder configured to fix the second servomotor to one side of the steel frame while supporting the second servomotor.

10. The apparatus according to claim 7, wherein the measurement unit includes:
a first load cell disposed between a linear motion guide, among the pair of linear motion guides, and the stiffness adjustment plate, the first load cell configured to measure frictional force; and
a second load cell disposed between the stiffness adjustment plate and the specimen holder, the second load cell configured to measure vertical load.

11. The apparatus according to claim 10, wherein the measurement unit further includes:
an accelerometer attached to the specimen holder, the accelerometer configured to measure vibration generated during a test; and
a microphone configured to measure noise generated during the test.

12. The apparatus according to claim 1, wherein the pair of test specimens are made of a same material.

13. The apparatus according to claim 12, wherein the pair of test specimens are made of leather or PVC (Polyvinyl Chloride).

14. The apparatus according to claim 1, wherein the pair of test specimens are made of different materials.

15. The apparatus according to claim 14, wherein one of the pair of test specimens is made of polymer and the other of the pair of test specimens is made of metal.

16. The apparatus according to claim 14, wherein the pair of test specimens are made of different polymer materials.
